(19) United States
(12) Patent Application Publication
(10) Pub. No.: US 2009/0272728 A1
(43) Pub. Date: Nov. 5, 2009

(54) COOKING APPLIANCES USING HEATER COATINGS

(75) Inventor: Richard C. Abbott, New Boston, NH (US)

Correspondence Address: WEINGARTEN, SCHURGIN, GAGNEBIN & LEBOVICI LLP, TEN POST OFFICE SQUARE, BOSTON, MA, 02109, US

(73) Assignee: THERMOCERAMIX INC., Shirley, MA (US)

(21) Appl. No.: 12/434,353

(22) Filed: May 1, 2009

Related U.S. Application Data
(60) Provisional application No. 61/126,095, filed on May 1, 2008.

(51) Int. Cl. A21B 1/02; B23P 17/00

(52) U.S. Cl. 219/399; 219/391; 219/402; 29/592.1

(57) ABSTRACT

An oven comprising a housing with a heating element having a heating layer, a support structure and a control system to control the operating temperature of the oven. The heater layer is preferably a thermally sprayed layer.

### RELATED APPLICATIONS

This application claims the benefit of U.S. Provisional Application No. 61/126,095, filed on May 1, 2008, the entire teachings of which are incorporated herein by reference.

### BACKGROUND OF THE INVENTION

Cooking processes involve the transfer of heat to food in a controlled way. Conceptually, heat is thought to transfer in three ways: conduction, convection and radiation. These processes are generally well-understood, and have been described by centuries-old mathematical methods.

In an electric oven, heat is commonly transferred by radiation from an electric heating element located within the oven cavity. The heating element in widest use currently is the Cal-rod, which is a wire, typically nickel-chromium, that is encapsulated in a nickel tube or sheath and insulated from the sheath by a crushed ceramic, such as magnesium oxide. The Cal-rod radiates heat in all directions, therefore much of the energy is directed to the walls of the oven instead of to the food. Moreover, the walls of the oven, which are typically covered in porcelain, absorb much of the radiated energy to heat the walls rather than reflect it back to the food being cooked.

Modern ovens frequently add a convection component, wherein a fan or blower moves air around the oven cavity so that the air is heated by the hot Cal-rod, and then circulates over and around the food, transferring its heat to cook the food. In gas-fired ovens, burners are located in the oven and deliver convective heat. Generally, one does not find conductive heat transfer in oven cooking, although conduction is often the fastest way to heat. Indeed, increased speed of cooking is a highly sought-after design parameter.

The conventional Cal-rod heating element is desirable for cooking applications because it is low cost and very robust. However, these heaters have the disadvantage of poor distribution of heat to the food being cooked. Other heating elements that have been proposed for cooking applications include thick film coatings of a resistive material. However, thick films are composed of glass and are subject to brittle fracture if thermal expansion conditions are not matched precisely. Other types of heater coatings include thin film resistive layers made by sputtering, chemical vapor deposition, and evaporation, for example, which are very costly and generally impractical for oven cooking.

### SUMMARY OF THE INVENTION

In a preferred embodiment of the invention, an oven comprises a housing with a heating element having a heating layer, a support structure and a control system to control the operating temperature of the oven. The heater layer is preferably a thermally sprayed layer. A thermal spray coating process can be used to deposit coatings that behave as heaters when electrically energized. In a preferred method for fabricating a heating element using thermal spray, a material in powder or wire form is melted and formed into a flux of droplets that are accelerated by means of a carrier gas towards the surface to be coated. The droplets impact the surface at high speed, sometimes supersonic speed, and very quickly solidify into flat platelets. By traversing the spray apparatus over the surface, a substantially lamellar coating comprising these solidified platelets is formed.

According to one aspect of the invention, a cooking oven comprises a plurality of walls defining a oven cavity and a heating element in thermal communication with the oven cavity. The heating element comprises at least one thermally-sprayed resistive heating layer, the resistive heating layer comprising a substantially lamellar structure comprising a first material and a second material, wherein the first material is an electrically conducting material and the second material is an electrically insulating material. An electrical connector can provide power to the resistive heating layer to generate heat.

The bulk resistivity and thus the heat generating capability of the heater element is raised by providing resistive heating layer composed of an electrically conductive material and an electrically insulating material, where the electrically insulating material has a higher electrical resistance than the electrically conductive material. In certain embodiments, the bulk resistivity of the resistive heating layer is higher than the resitivity of the conductive material by a factor of about 10 or more. In other embodiments, the bulk resistivity of the resistive heating layer is higher than the resistivity of the conductive material by a factor of about 10 to about 1000. The content of the electrically insulating material in the resistive heating layer can comprise at least about 40% by volume, and in certain embodiments, comprises between about 40-80% by volume.

The resistive heating layer can be thermally sprayed on a support substrate, which can comprise a wall of the oven cavity. Where the support substrate is electrically conductive, it may be necessary to deposit an electrically insulating layer on the substrate, and the resistive heating layer over the insulating layer. The electrically insulating layer can be thermally sprayed on the support substrate. The resistive heating layer can be located outside or inside the oven cavity. Where the support substrate is electrically insulating, the heating layer can be thermally sprayed directly on the substrate.

The heating element preferably comprises a flat-panel heater that can form, or be housed within or mounted adjacent to a wall of an oven cavity. The heating element can comprise a pre-defined circuit pattern on a support substrate. The heater can advantageously distribute its heat uniformly over a broad surface. Heater panels can be disposed on multiple surfaces within or around the oven cavity to provide substantially uniform distribution of radiant heat energy inside the oven cavity. A heater panel can be suspended from the top wall of the oven cavity to provide intense radiant heat, such as for broiling.

An oven according to the invention can further include a convection component, including, for example, an air circulation system that provides an air stream in thermal contact with the heating element. A resistive layer heating element of the invention can also be located inside the air circulation system, such as on a surface of a blower, for enhanced heat transfer to a convection air stream.

A heater element of the invention can be disposed on a surface of the oven cavity to provide a conductive cooking surface. The conductive cooking surface can include a shelf within the oven cavity. The shelf can be a partition to create a dual oven. The shelf can comprise a first heating element on one side of the shelf and a second heating element on the opposite side of the shelf separated by an insulating layer. The two heating elements can be separately controllable by the oven control system.

In other aspects, the heater element can be disposed on an oven rack that can be mounted within the oven cavity and electrically connected to the oven. The heater element can be disposed on a container that can be housed within the oven cavity and electrically connected to the oven.

In still further embodiments, the oven can comprise a high temperature (e.g., 650-700°) pizza oven having one or more resistive heating layers formed by a thermal spray process. The pizza oven can include a coating within the oven cavity to provide a stone-like appearance. The coating can be formed by thermal spray, and can comprise cordierite or other ceramic materials.

In various other aspects, the present invention is directed to heating elements for an oven having thermally-sprayed resistive heating layers, and methods of fabricating ovens and oven heating elements using thermally sprayed coatings.

### BRIEF DESCRIPTION OF THE DRAWINGS

FIG. 1 is an illustration of the microstructure of a thermally-sprayed heater layer in accordance with the invention;

FIG. 2A is a cross-sectional view of a layered heater element in accordance with one aspect of the invention;

FIG. 2B is a plan view of the heater element of FIG. 2A;

FIG. 3 is an elevational front view of an oven;

FIG. 4 is a perspective view of an oven with heater panels on five walls in accordance with one embodiment of the invention;

FIG. 5 is a perspective view of an oven having an internal radiant heater in accordance with an embodiment of the invention;

FIG. 6 is a perspective view of an oven having heater panels and a blower for convection heating;

FIG. 7 is a perspective view of a blower for a convection oven having a heater coating in accordance with one aspect of the invention;

FIG. 8 is a perspective view of an oven having a removable partition with a heater coating;

FIG. 9 is a perspective view of an oven having a rack with a heater coating on the rack;

FIG. 10 is a perspective view of an oven having a pan with an integral heater element in the pan;

FIG. 11 is a perspective view of a pizza oven having a heated shelf and heater coating elements on top and bottom surfaces of the oven;

FIG. 12 is a perspective view of a pizza oven having ceramic wall inserts;

FIG. 13 illustrates bottom and top views of a cooktop burner with an integral heater coating;

FIG. 14 illustrates top and bottom views of a cooktop burner with a separate heater mounted on a mica plate; and

FIG. 15 illustrates a glass cooktop with a heater coating mounted to the underside of the cooktop.

### DETAILED DESCRIPTION OF THE INVENTION

This application claims the benefit of U.S. Provisional Application No. 61/126,095, filed on May 1, 2008, the entire teachings of which are incorporated herein by reference.

Resistive heating elements can be formed by a thermal spray process. Thermal spray is a versatile technology for depositing coatings of various materials, including metals and ceramics. It includes systems that use powder as feedstock (e.g., arc plasma, flame spray, and high velocity oxy-fuel (HVOF) systems), systems that use wire as feedstock (e.g., arc wire, HVOF wire, and flame spray systems), and systems using combinations of the same.

Arc plasma spraying is a method for depositing materials on various substrates. A DC electric arc creates an ionized gas (a plasma) that is used to spray molten powdered materials in a manner similar to spraying paint.

Arc wire spray systems function by melting the tips of two wires (e.g., zinc, copper, aluminum, or other metal) and transporting the resulting molten droplets by means of a carrier gas (e.g., compressed air) to the surface to be coated. The wire feedstock is melted by an electric arc generated by a potential difference between the two wires.

In flame spray, a wire or powder feedstock is melted by means of a combustion flame, usually effected through ignition of gas mixtures of oxygen and another gas (e.g., acetylene).

HVOF uses combustion gases (e.g., propane and oxygen) that are ignited in a small chamber. The high combustion temperatures in the chamber cause a concurrent rise in gas pressure that, in turn, generates a very high speed effluent of gas from an orifice in the chamber. This hot, high speed gas is used to both melt a feedstock (e.g., wire, powder, or combination thereof) and transport the molten droplets to the surface of a substrate at speeds in the range of 330-1000 m/sec. Compressed gas (e.g., compressed air) is used to further accelerate the droplets and cool the HVOF apparatus.

Other systems, typically used for materials having a relatively low melting point, impart very high velocities to powder particles such that the particles are melted by conversion of kinetic energy as they impact the substrate.

A thermal sprayed coating has a unique microstructure. During the deposition process, each particle enters a gas stream, melts, and cools to the solid form independent of the other particles. When particles impact the surface being coated, they impact (“splat”) as flattened circular platelets and solidify at high cooling rates. The coating is build up on the substrate by traversing the spray apparatus (gun) repeatedly over the substrate, building up layer by layer until the desired thickness of coating has been achieved. Because the particles solidify as splats, the resultant microstructure is substantially lamellar, with the grains approximating circular platelets randomly stacked above the plane of the substrate.

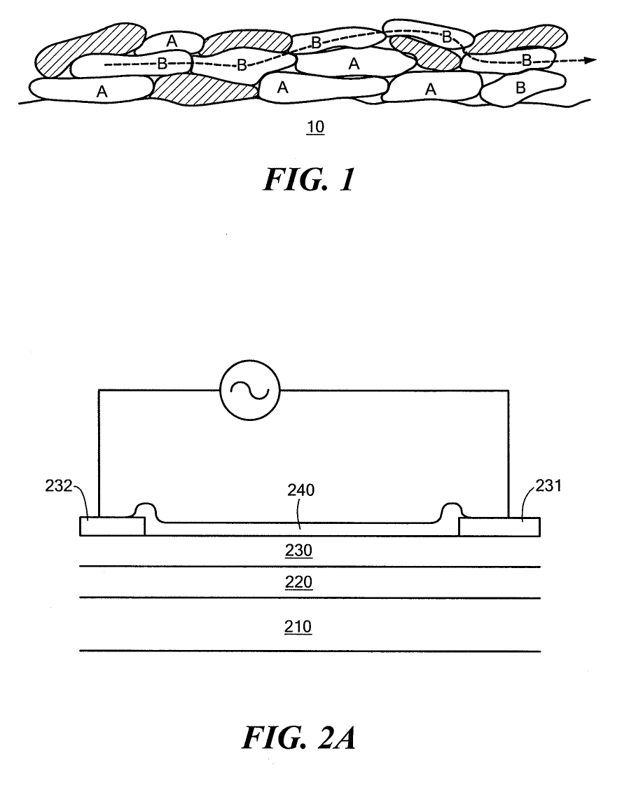

If the starting materials for forming the resistive heating layer consists of a blend of two or more different materials, the sprayed coating microstructure can be a lamellar array of two or more kinds of grains. As shown in FIG. 1, the two different materials can be viewed as forming two interpenetrating, interconnected lattices with the degree of interconnection being a function of the proportion of material that is present. In particular, if one material happens to be electrically insulating, and one electrically conducting, then the conductivity (or resistivity) will depend on the degree of interconnectedness of the conducting material. In FIG. 1, the deposited microstructure includes three discrete phases of different materials deposited on a substrate 100. Materials A and B are insulator and conductor, respectively. The cross-hatched phase represents additional material(s) that can be optionally added for engineering purposes, such as adhesion, thermal expansion, thermal conductivity, and emissivity. The dashed line indicates the electrical current path through the lattice.

For a deposited coating to use a desired power level to generate a particular amount of heat when a voltage is applied, the coating generally must have a particular resistance that is determined by the desired power level. The resistance, R, is calculated from the applied voltage, V, and the desired power level, P, as follows:

R=V²/P

The resistance of the coating is a function of the geometry of the coating. Specifically, the resistance of the coating can be measured in terms of the electric current path length (L) the cross sectional area (A) through which the current passes, and the material resistivity (ρ) by the following equation:

R=ρ·L/A

Therefore, to design a coating for a given power level and a given geometry that will operate at a given voltage, one has only to determine the resistivity of the material using the following equation:

ρ=R·A/L=V²·A/(P·L)

A composition having the necessary resistivity, p, can be obtained, for example, by using varying blends of conductors and insulators in the feedstock until a coating having the necessary resistivity is found empirically. According to another technique, as described in further detail below, the resistivity can be controlled, at least in part, by controlling an amount of a chemical reaction that occurs between the feedstock (such as a metal) and a gas that reacts with the feedstock (such as an ambient gas) during the deposition process.

That the resistivity is a controlled variable is significant because it represents an additional degree of freedom for the heater designer. In most situations, the resistivity of the heater material, e.g., nickel-chromium, is a fixed value. In such an instance, the heater designer must arrange the heater geometry (L and A) to obtain the desired power. For example, if it is desired to heat a tube by winding nickel-chromium wire around it, the designer must choose the correct diameter wire for A, the cross sectional area through which the electric current must pass, and the spacing of the windings for L, the total path length of the electric current.

Thermally-sprayed coatings that behave as electrical heaters can be composed of any electrically conducting material, but it is generally advantageous to chose materials that possess high electrical resistivity. This allows generation of power with high voltages and lower currents, preferably commonly used voltages such as 120 V or 240 V. It can be even more advantageous to boost the resistivity of heater coatings greater than the typical value of common materials, e.g. nickel-chromium, by adding insulating components, such as metal oxides, to the thermally-sprayed coating layer. This has the effect of allowing the design of heater coatings with compact dimensions, in particular shorter current paths, and making them eminently practical for use in a variety of applications.

According to one aspect of the invention, a heater coating deposited by thermal spray comprises an electrically conductive material and an electrically insulating material, the electrically insulating material having a higher electrical resistance than the electrically conductive material, such that the bulk resistivity (ρ) of the heater coating is raised relative to the electrically conductive material. In certain embodiments, the bulk resistivity is raised by a factor of approximately 10¹ or more. In other embodiments, the bulk resistivity is raised by a factor of about 10¹ to about 10³ above the resitivity of the electrically conductive material. According to certain embodiments, the content of the insulating material(s) in the heater coating comprises at least about 40% by volume, and in a preferred embodiment, between about 40-80% by volume.

Examples of materials that can be used to form an electrically conductive component in a thermally-sprayed heater coating include, without limitation, carbides such as silicon carbide or boron carbide, borides, silicides such as molybdenum disilicide or tungsten disilicide, and oxides such as lanthanum chromate or tin oxide which have electroconducting properties that are appropriate for the technology. For the insulating material, oxides are very good in the application, particularly Al₂O₃, which is refractory, insulating, and inexpensive. Aluminum nitride and mullite are also suitable as insulating materials.

Metallic component feedstocks can also be used to form the electrically conductive component of the heater coating, and in particular metallic components that are capable of forming an oxide, carbide, nitride and/or boride by reaction with a gas. Exemplary metallic components include, without limitation, transition metals such as titanium (Ti), vanadium (V), cobalt (Co), nickel (Ni), and transition metal alloys; highly reactive metals such as magnesium (Mg), zirconium (Zr), hafnium (Hf), and aluminum (Al); refractory metals such as tungsten (W), molybdenum (Mo), and tantalum (Ta); metal composites such as aluminum/aluminum oxide and cobalt/tungsten carbide; and metalloids such as silicon (Si). These metallic components typically have a resistivity in the range of 1−100×10⁻⁸ Ω·m. During the coating process (e.g., thermal spraying), a feedstock (e.g., powder, wire, or solid bar) of the metallic component is melted to produce droplets and exposed to a reaction gas containing oxygen, nitrogen, carbon, and/or boron. This exposure allows the molten metallic component to react with the gas to produce an oxide, nitride, carbide, or boride derivative, or combination thereof, over at least a portion of the droplet.

The nature of the reacted metallic component is dependent on the amount and nature of the gas used in the deposition. For example, use of pure oxygen results in an oxide of the metallic component. In addition, a mixture of oxygen, nitrogen, and carbon dioxide results in a mixture of oxide, nitride, and carbide. The exact proportion of each depends on intrinsic properties of the metallic component and on the proportion of oxygen, nitrogen, and carbon in the gas. The resistivity of the layers produced by the methods herein can range from 500−50,000×10⁸ Ω·m.

Exemplary species of oxide include TiO₂, TiO, ZrO₂, V₂O₅, V₂O₃, V₂O₄, CoO, CO₂O₃, CoO₂, CO₃O₄, NiO, MgO, HfO₂, Al₂O₃, WO₃, WO₂, MoO₃, MoO₂, Ta₂O₅, TaO₂, and SiO₂. Examples of nitrides include TiN, VN, Ni₃N, Mg₃N₂, ZrN, AlN, and Si₃N₄. Exemplary carbides include TiC, VC, MgC₂, Mg₂ C₃, HfC, Al₄C₃, WC, MO₂C, TaC, and SiC. Exemplary borides include TiB, TiB₂, VB₂, Ni₂B, Ni₃B, AlB₂, TaB, TaB₂, SiB, and ZrB₂. Other oxides, nitrides, carbides, and borides are known by those skilled in the art.

In order to obtain oxides, nitrides, carbides, or borides of a metallic component, the gas that is reacted with the component must contain oxygen, nitrogen, carbon and/or boron. Exemplary gases include, for example, oxygen, nitrogen, carbon dioxide, boron trichloride, ammonia, methane, and diborane.

During the thermal spray process, when the molten droplets of the metallic feed react with ambient gas present in the flux stream, the composition of the coating differs from that of the feedstock. The droplets can obtain, for example, a surface coating of the reaction product (e.g., an oxide, nitride, carbide, and/or boride derivative of the metallic component). Some droplets can react completely, while others can retain a large fraction of free metal, or can remain un-reacted. The resulting microstructure of the coating is a lamellar structure, which can consist of individual particles of complex composition. The coating has a reduced volume fraction of free metal with the remainder consisting of reaction products. When the gases that are added to the flux stream are chosen to form reaction products having a higher electrical resistivity than the starting metallic material, then the resulting coating exhibits a bulk resistivity that is higher than the free metallic component. The concentration of reaction product, and thus the resistivity of the coating layer, can be controlled, at least in part, by controlling the concentration of the reaction gas.

In certain embodiments, the resistivity of the heater coating can be further enhanced by selecting a feed stock for a thermal spray process that includes at least one electrically conductive component and at least one electrically insulating component, and where at least one component of the feed stock comprises a metallic component that reacts with a reactant gas during the thermal spray process to produce a reaction product having a higher resistivity than the free metallic component. For example, in one preferred embodiment of the invention, the feed stock for the thermally sprayed heater layer comprises a flat metal ribbon that is formed into a wire that surrounds a core of an insulating material. The insulating material can be a powder, such as a powdered ceramic. In one embodiment, a flat metal ribbon is formed into a wire over an insulating powder of aluminum oxide. This “cored” wire is then thermally sprayed, preferably using a twin arc wire system, in the presence of a reaction gas, to produce a coating on a suitable substrate. The resulting thermally sprayed coating is characterized by substantially increased resistivity relative to aluminum alone, as a result of both the ceramic aluminum oxide powder in the feed material, as well as the electrically insulative reaction product (e.g., aluminum oxide) formed by the reaction of the molten aluminum metal and the reaction gas (e.g., oxygen). Thus, a cored wire feed stock of aluminum metal and aluminum oxide ceramic provides the benefit of the extraordinary sticking power of aluminum and the high-resistivity of a large volume fraction of aluminum oxide where normally aluminum, even with an oxidized component, typically has a low resitivity.

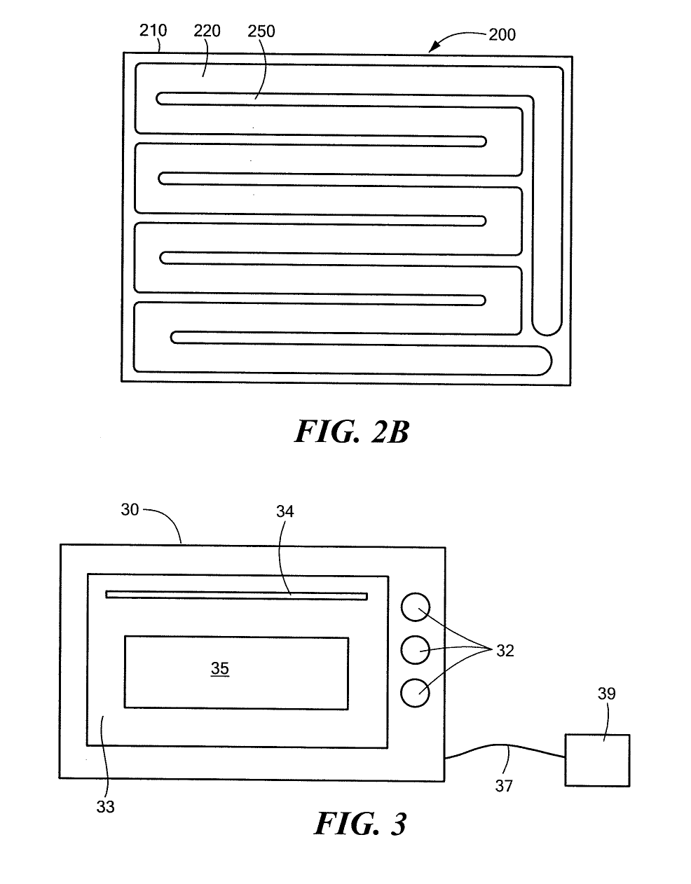

Turning now to FIG. 2A, an exemplary embodiment of an electric resistance heater 200 of the present invention is illustrated. The heater 200 includes a substrate 210, which can be an engineering material, such as a steel plate, that can comprise, for example, a wall of a cooking oven. The surface of the substrate 210 can be roughened, by grit blasting for example, to promote better adhesion of the coating layer(s). When the substrate is a metal or other electrical conductor, it is necessary to deposit an electrically insulating layer 220, such as a polymer or ceramic, over the substrate 210 to insulate the substrate 220 from the resistance heater layer. The insulating layer 220 can comprise any suitable insulating material (e.g., aluminum oxide, zirconium oxide, magnesium oxide, etc.), and can be applied by any suitable method. The insulating layer 220 can be deposited by a thermal spray process, such as the processes described above. Next, a resistive heater coating layer 230 is applied by a thermal spray process, as described above. Electrical contact pads 231, 233 are provided in contact with the heater layer 230 in order to connect a voltage across the heater layer 230 and generate heat resistively. The heater layer 230 can be connected to a power source by any suitable method, such as brazing connectors, soldering wires, or by physical contact using various mechanical connectors.

It is frequently necessary to cover the heater layer 230 to protect users from electric shock and/or protect the heater from environmental effects such as moisture. This can be done by overcoating the heater layer 230 with another insulating layer 240 of a ceramic or polymer, such as aluminum oxide, or by encapsulation of the heater in an enclosure.

It will be understood that numerous variations of the above-described heater 200 can be made consistent with the particular application. For instance, additional layers and coatings can be provided for various purposes, including, without limitation, an adhesion or bond layer on the substrate, layers for improved thermal matching between layers with different coefficients of thermal expansion, and one or more layers to promote or inhibit heat transfer, such as a thermally emissive layer, a thermally reflective layer, a thermally conductive layer, and a thermally insulative layer. It will also be understood that a resistive heater layer 230 may be deposited directly onto a non-conductive substrate without an electrically insulating layer 220.

A heater 200 such as described above in connection with FIG. 2A can have any desired shape. In a preferred embodiment of a heater 200 for a cooking oven, the heater 200 comprises a flat panel heater that can form, or be housed within or mounted adjacent to, a wall of an oven cavity. An example of a flat panel heater 200 is illustrated in FIG. 2B. Such a design is advantageous and can dramatically improve oven performance since the heater 220 distributes its heat uniformly over a surface rather than concentrating it along a wire. As can be seen in FIG. 2B, the resistive heater layer 220 comprises a defined circuit pattern on the substrate 210, separated by insulated regions 250. The circuit pattern can be defined during the thermal spray process using a removable patterned mask. The circuit pattern could also be formed after the heater layer 220 is coated on the substrate, such as by microabrasion, or scribing the pattern with a laser or a cutter.

FIG. 3 shows one embodiment of an oven 30, according to one aspect of the invention. The oven 30 generally includes a heating cavity or enclosure defined by top, bottom, front, rear and side surfaces, and a door 33, typically located at the front of the oven 30, and pivotably mounted to the oven to provide access to the interior heating cavity. The door 33 can have a handle 34 to permit an operator to open and close the door, and a window 35 to permit the operator to view the interior cavity. The oven 30 can include controls and/or indicators 32 for controlling the operation of the oven 30. The oven 30 is connected to a power supply 39 by an electrical connection 37. The power supply 39 can be a conventional power supply that provides power to the heating element(s), as well as other components of the oven that require power (e.g., convection fan, display panel, associated electric cooktop, etc.). A conventional power supply may provide a voltage of 100 volts (V) or 220 volts (V), such as from a household utility source. A power supply that provides more than 220 V or less than 110 V, or any voltage in between, may be utilized.

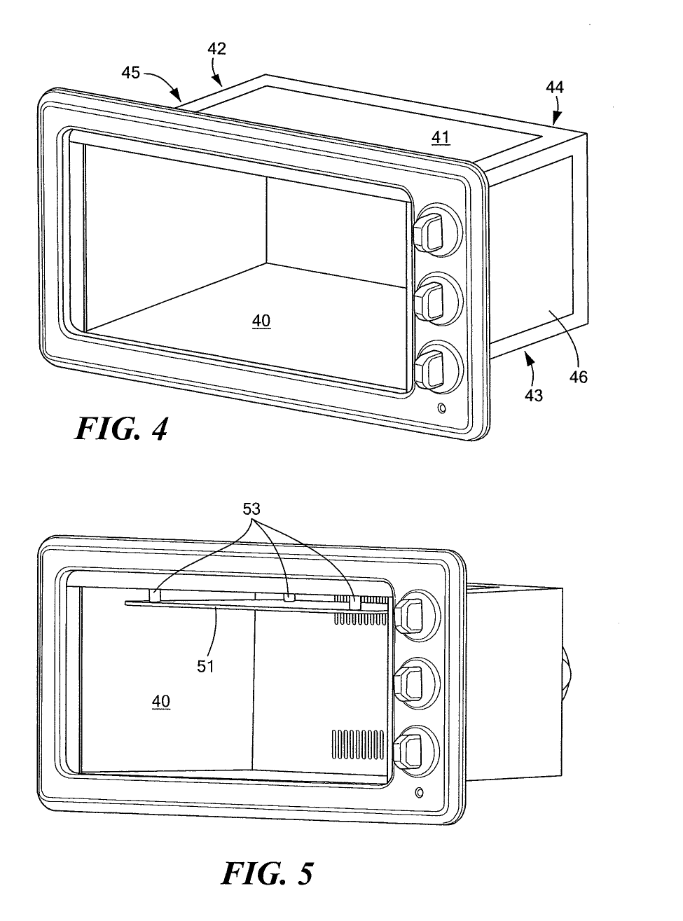

FIG. 4 is a perspective view of an oven 30 according to one embodiment of the invention. The door 33 is not present to illustrate the interior heating cavity 40 of the oven. Panels 41, which comprise flat panel heaters having a thermally-sprayed resistive heater coating, are located on one or more of the walls defining the interior heating cavity 40 of the oven. In the embodiment of FIG. 4, the heater panels 41 are located on five walls of the oven, including the top 42, bottom 43, rear 44, left side 45 and right side 46 walls. The heater panels 41 can be disposed on any number of surfaces in thermal communication with the oven cavity 40. The heater 41 can also be disposed on a front surface of the oven, including on an oven door. Preferably, the heater panels are disposed on multiple surfaces around the oven cavity to promote uniform distribution of radiant heat energy inside the oven cavity. When heat is distributed uniformly over the oven walls, the effect is similar to that of a brick oven, where the food receives radiant energy from all directions and in a uniform manner. This is generally considered the best mode of baking.

Heater coating panels can be deposited directly on the oven walls, on interior or exterior surfaces of the oven walls, or on both. Thermally sprayed heaters can advantageously be deposited directly on engineering materials used to form the oven walls, such as steel. This is distinguishable from heater coatings deposited by certain other methods, such as thick film deposition, which are subject to brittle fracture if thermal expansion conditions are not matched precisely. Cracking of the coatings, particularly of the insulating layer between the resistive heater and a metal support substrate, is particularly problematic, since this results in excessive current leakage and dielectric breakthrough. It has been found that fabrication of the heater element using thermal spray processes greatly minimizes or eliminates these problems. Thermally-sprayed resistive heating elements bond extremely well to materials, including metal materials, commonly used to produce oven walls, such as mild steel, stainless steel (e.g., 300 series), ferritic stainless steel (e.g., 400 series), aluminum, and titanium. Furthermore, the flexibility of thermal spray processes and materials enables coating layers to be formed having good thermal matching characteristics. It has been found that thermal sprayed restive heater elements can maintain their integrity, functionality and dielectric strengths for prolonged periods at high temperatures (e.g., up to 440° C. on aluminum substrate, 600° C. on 300-series steel, 750° C. on 400-series steel, and 900° C. on titanium).

In other embodiments, the heater panel can be formed on a separate substrate which is then mounted on or in the oven to provide heat to the oven cavity 40. In the embodiment of FIG. 4, the heater coating layer is formed on a panel of an insulating material, and the panel is mounted to the exterior surfaces of the oven walls. The use of a separate heater panel can be advantageous for ease of manufacture, to minimize capacitive leakage currents, and for ease of maintenance and replacement. The panel of insulating material can comprise mica, which has good dielectric properties, and is relatively low cost. Alternatively, the heater coating could be deposited on a polymer film, such as a polyimide, which is then attached to the oven wall(s) using a suitable adhesive.

When the heater panel is mounted on the outside of the oven walls, such as shown in FIG. 4, it is important that there is sufficient transmission of thermal energy through the oven walls and into the oven cavity. If the interior walls of the oven are coated in porcelain, which has a very high thermal emissivity, the heaters on the outside of the oven will benefit from maximum radiant efficiency while being protected from environmental factors, such as food or carbon stains. It may further be advantageous to provide a thermal insulating material, such as a thermal insulating blanket, over the outside of the heater so that most of the heat energy is directed into the oven cavity.

Where the heater panel functions inside the oven cavity, it is generally preferable that the heater coatings are insulated for safety and hygienic reasons. If the heater is formed on an insulating substrate, such as a mica panel, a second mica or insulator layer can be bonded to the top (heater) surface. If the heater is deposited on a metal panel, another metal panel can be attached to form a complete enclosure, or alternatively, a glass, porcelain or ceramic layer can be deposited over the heater for protection. A steel panel with a heater coating layer deposited on it can be completely encapsulated in porcelain so that both steel and heater are protected.

FIG. 5 illustrates an alternative embodiment of an oven having a heater panel 51 attached to the top wall 42 of the oven and suspended inside the oven cavity 40. A suspended panel 51 can deliver intense radiant heat that may be required for broiling, for example, without subjecting the oven wall to that same temperature. A suspended panel 51 also lends itself to efficient transfer of heat to air that may be blown over the panel by a circulating system used to provide conductive heating.

The suspended panel 51 can be formed using any of the methods and materials used to form the resistive heater panels 41 described above in connection with FIG. 4. The panel 51 is spaced from an interior wall of the oven by one or more spacers, such as posts 53. One or more panels 51 can be mounted to any interior wall of the oven, and spaced away from the wall using suitable spacers.

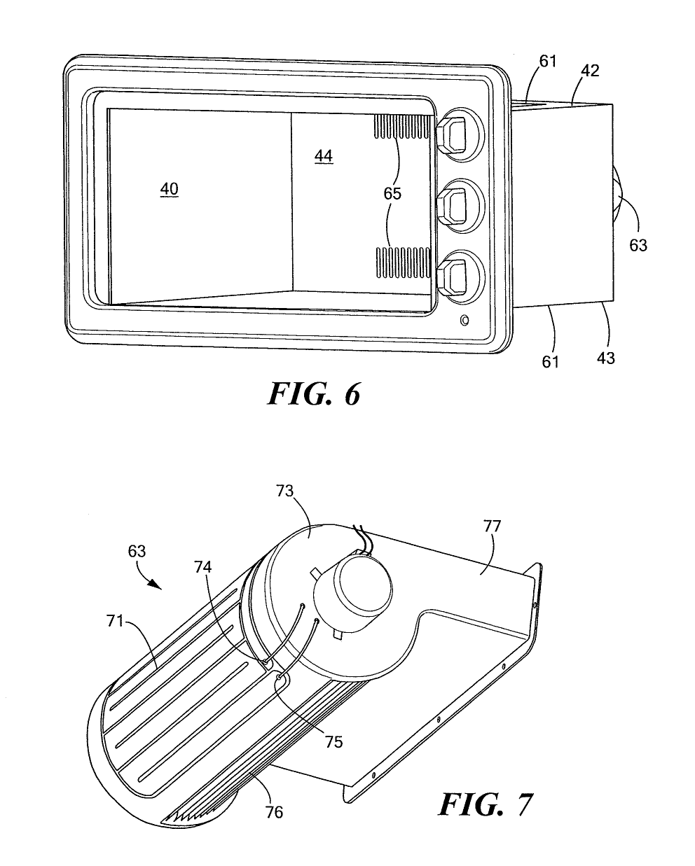

FIG. 6 illustrates a convection oven 60 having heater coating elements in accordance with the invention. Convection ovens using heater coatings can demonstrate very fast heat-up rates because of efficient heat transfer to air. In the convection oven of FIG. 6, the oven includes one or more heater panels 61 located on or adjacent to the oven wall(s), and in thermal communication with the oven cavity 40. The heater panels 61 can be identical to the panels described above in connection with FIGS. 4 and 5, and can provide a component of radiant heat to an object within the oven cavity 40. In this embodiment, heater panels 61 are mounted on the exterior surface of both the top 42 and bottom 43 walls of the oven. It will be understood that heater panels 61 can be located on additional surfaces, on both the outside and inside walls of the oven cavity. In addition, the convection oven 60 includes an air circulation system to provide a conductive heating component. In this embodiment the air circulation system comprises a blower 63 that is mounted behind the rear wall 44 of the oven. The blower 63 produces an air stream that is directed into the oven cavity 40 via vent apertures 65 in the rear wall 44 of the oven. Air that is forced by the blower 63 passes over the surfaces heated by heater panels 61 and therefore picks up heat for transfer to an object (such as a food substance) located in the oven cavity 40. Heat transfer to the circulating air is enhanced due to the large area of the heater panels 61. This is in contrast to a conventional convection oven that typically has only a small fraction of air passing over the Cal-rod heating element.

If heater coatings are inserted into the oven cavity on separate panels, such as the suspended panel 51 illustrated in FIG. 5, air that is forced over the panel 51 will receive a larger amount of heat more quickly than a conventional Cal-rod style oven because of the larger surface area over which the heater 51 is disposed.

Other advantages of the present convection oven include enlargement of the usable space in the oven cavity because of the absence of conventional heating elements, less assembly time, rapid heat-up and high efficiency.

Panels 61 containing heater coatings can be placed anywhere in the air stream, preferably where a large proportion of the flowing air flows over either the panels themselves, or else over surfaces heated by the panels, for efficient heat transfer to the circulating air. The panels 61 or heating surface(s) can be modified with features such as ripples or asperities to induce turbulence at the surface for improved heat transfer. Vanes or apertures can also be provided to purposely direct the airflow over heated surfaces in the oven cavity. In addition, heat transfer can be enhanced by arranging air flow so that the air stream is not parallel to the heat transfer surface, but is perpendicular or at an angle relative to the heated surface. This induces turbulence, hence improved heat transfer, when the air is forced to change direction at the heated surface.

As shown in FIG. 7, heater coatings 71 can be incorporated into the blower 63 itself to improve heat transfer to the circulating convection air. In this embodiment, essentially all the air that is forced by the blower passes over the heater coating 71 and therefore picks up heat for transfer to the oven cavity 40. The heater coatings 71 comprise a resistive heating layer that can be thermally-sprayed onto the blower housing 73, and patterned to provide a resistive heating circuit when a voltage is provided across electrodes 74, 75. The heater coatings 71 can be applied to any surface on or within the blower 63. A motorized fan 76 forces air to flow proximate the heater coating 71, where the air is heated, and then into the oven via an air duct 71.

According to still further aspects, the present invention relates to ovens that rely on conductive heat transfer. Heat that flows by conduction often offers the fastest heat up rates because the heat can be focused more easily and the oven can be configured with less impedance to the flow of thermal energy to the load, i.e. the food. For an oven, generally that requires providing a heat source that is in contact with the food or the food container. In most ovens, the food container is placed on either a rack or a shelf in the oven cavity. According to certain embodiments of the invention, a conductively heated oven comprises a shelf or rack having thermally-sprayed heater elements located on the shelf or rack to provide conductive heat transfer to a food item located on the shelf or rack.

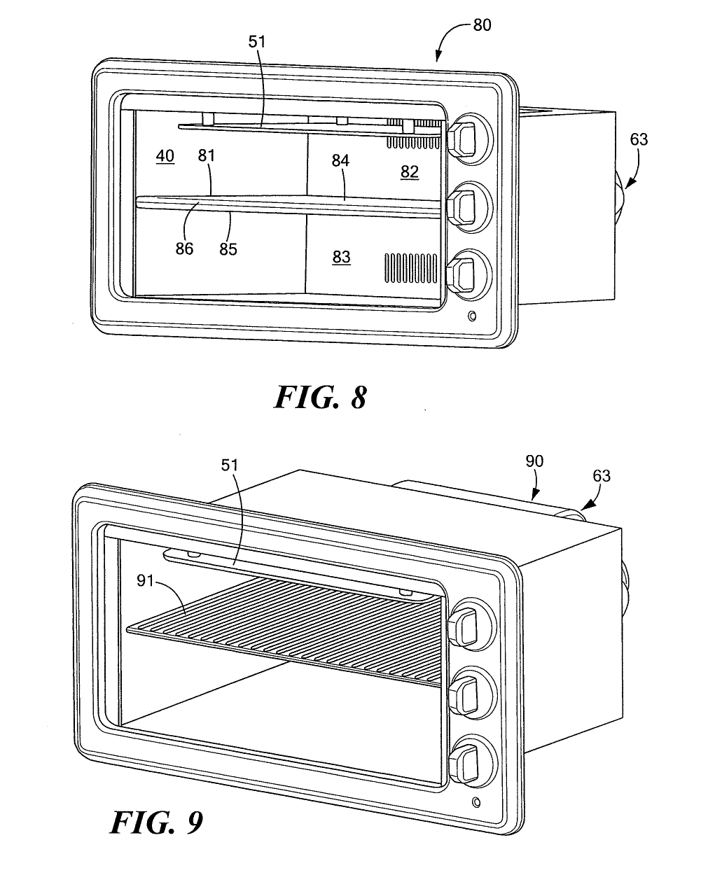

FIG. 8, for example, illustrates an oven 80 having a shelf 81 located inside the oven cavity 40. The shelf 81 can be removable, and the height of shelf 81 may be adjustable, similar to a conventional oven rack. The shelf 81 includes an electrical resistance heating element comprising a thermally-sprayed heater coating layer. The heater element can comprise a patterned, flat-panel heater such as described in connection with FIGS. 2A and 2B. The shelf 81 preferably includes an electrical connection means that connects to a mating connector in the oven cavity to provide power to the heater element. For example, the shelf 81 can include an electric plug that plugs into a socket located on an interior wall of the oven cavity. When the shelf 81 is energized, the resistive heating element generates heat that can be conducted very quickly to a load (i.e. a cooking pan) resting on the shelf. The shelf 81 can divide the oven into two separate oven cavities 82, 83 to form a double oven. The shelf 81 can comprise two separate heating elements: element 84 located on the top of the shelf and element 85 on the bottom of the shelf, separated by a thermal insulator 86. The control system of the oven can be configured such that each of the heater elements 84 and 86 are independently controllable so that the temperature in cavities 82 and 83 can be separately controlled. In the embodiment shown in FIG. 8, a suspended heating panel 51 such as described in connection with FIG. 5 can deliver intense radiant heat in the upper oven cavity 82, which in conjunction with the conductive heating provided by shelf element 84 can provide a very uniform and rapid food heating system. A convective heating component can also be provided by blower 63.

FIG. 9 illustrates an oven 90 having a heated oven rack 91. The rack 81 has heater coatings located on its bars, which can be deposited on the top or bottom of the bars (or both) using a thermal spray process. The rack 91 can be removable from the oven cavity 40, and its height can be adjusted as with a conventional oven rack. The heated rack 91 can include a suitable mechanism for making an electrical connection to the oven power source, such as electrical connectors at one end of the rack to draw power from electrical plugs located at the back of the oven. The energized heating elements on the rack 91 can provide conductive heat transfer to a food container located on the rack 91. The rack 91 could also serve as a grill with food placed directly on the rack 91. The heated rack 91 can heat food in conjunction with a top radiant panel 51 and a convection blower 63. The openings between the bars of the rack 91 allow air to flow around and through the rack for convection heating, and also allow grease to drip through if food is placed directly on the rack 91.

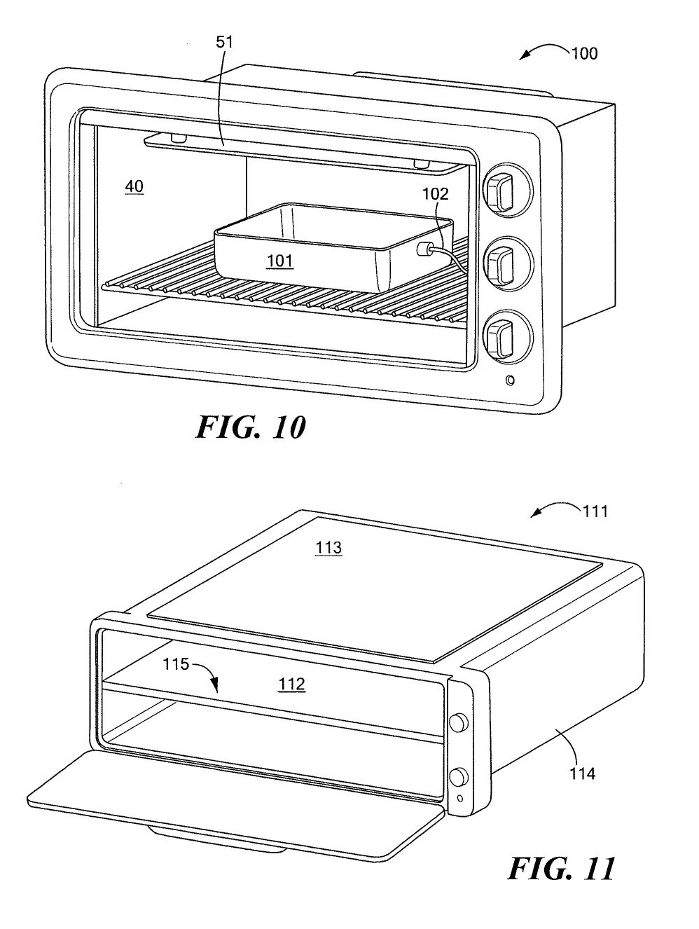

FIG. 10 illustrates an oven 100 having a container, such as a pan 110, with an integral heater element in the pan 110. The heater element comprises a resistive heating element that is deposited on a surface of the pan 110 by a thermal spray process. The heating elements provide conductive heat to a food item within the pan 110. The pan 110 can be placed inside the oven cavity 40, and preferably has an electrical connector, such as a power cable 102, for connecting the heating element to the oven power supply. While the pan 110 heats the food conductively, the oven 100 provides additional heat, such as radiative heat from a panel heater 51 mounted inside the oven cavity. The combined heating from the pan 110 and the oven 100 can both be controlled by the oven control system to provide a very uniform and rapid food heating system.

In other embodiments, the present invention relates to a pizza oven having a thermally-sprayed resistive heating layer. Pizza ovens are generally characterized by low, broad cavities for large flat pies, and typically operate at high temperatures (e.g. 650-700° F.). For rapid and even baking, it is desirable to have a uniform and constant flow of heat to the pie. This explains why brick oven baking or the use of a heated stone is generally considered the best method for baking pizza. Brick and stone have high heat capacity, meaning they require a lot of heat to rise to a given temperature. The high heat capacity also means that a lot of heat is stored in the stone, so that during baking the food does not draw off much of the stone's total energy. Therefore the stone can remain fairly constant and uniform in temperature to provide even baking of the pizza.

Where a stone provides conductively transferred heat, a brick oven provides radiatively transferred heat. However, because of the high heat capacity of the brick, heat is radiated to the pizza evenly from all directions, and at a substantially constant rate.

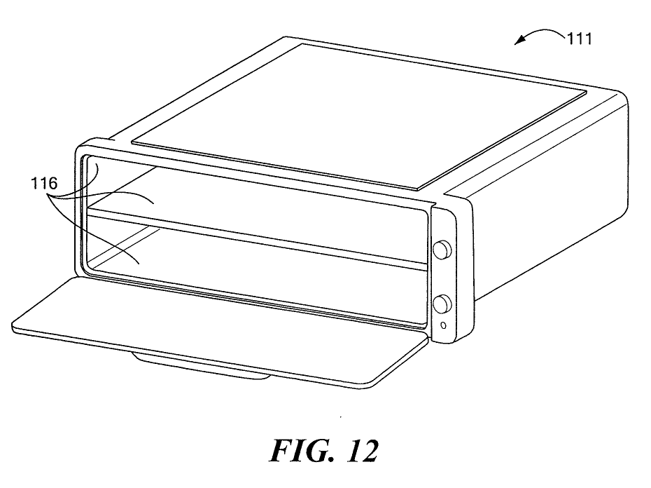

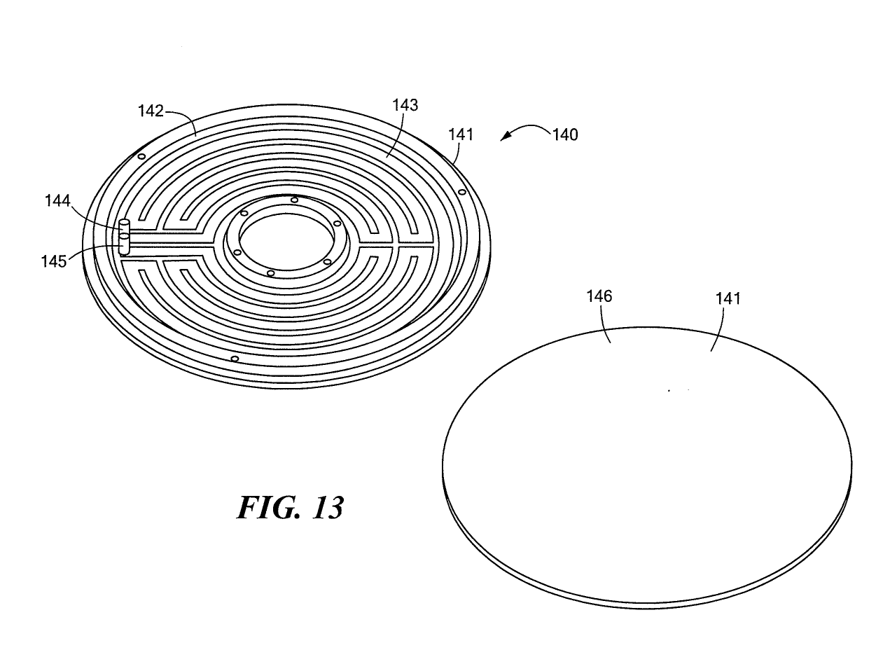

Heater coatings of the present invention have substantially the same effect as brick ovens or heated stones because they can be configured to provide both conductive heat with constant temperature and uniform heat flux as well as radiative heat with constant flux from all directions. FIG. 11 depicts a pizza oven 111 with a heater coating 112 on a shelf 115 within the oven cavity 40 and heater coatings 113, 114 on the top and bottom walls of the oven. The shelf heater 112 provides uniform, constant heat flux conductively upwards to a pan resting on the shelf 115, and uniform, constant heat flux radiatively downward to a pie resting on the bottom wall of the oven 111. Two separate heater elements separated by an insulator can be provided on the shelf, similar to the partition shelf described above in connection with FIG. 8. Multiple cavities can be configured for baking more than two pizzas or a single cavity can be configured for baking one pie at a time. A convection feature may be added as described in connection with FIGS. 6 and 7.

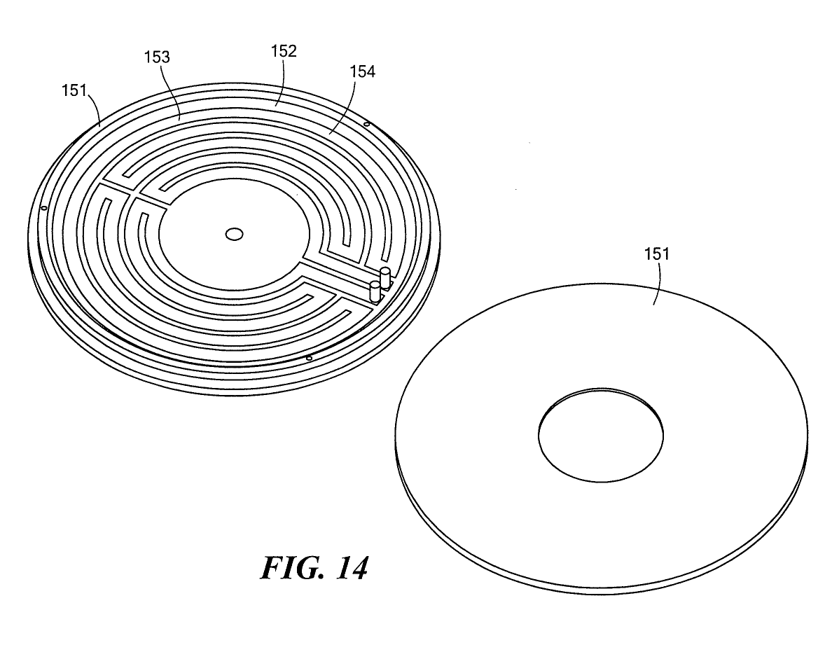

For commercial and/or aesthetic reasons, it may be desirable to add a stone-like appearance to a pizza oven. FIG. 12 illustrates a pizza oven 111 having slabs 116 of cordierite or other appropriate ceramic located on the shelf and oven walls. Heater coatings may be located below the ceramic layers 116, or within the layers 116, as desired. Alternatively, cordierite or other ceramic material may be deposited as coatings on the metal walls of the oven using, for example, thermal spray, to give the appearance of a brick oven and to provide high thermal emissivity.

In other embodiments, the present invention relates to a cook top, such as a burner or a glass cook top, having a thermally-sprayed resistive heating layer. Cook tops can utilize radiant, convection and/or conductive heat transfer in order to cook food. For electric cooking surfaces, heat is generated by heating element (most commonly a coiled Cal-rod) and conducted into the cooking utensil placed in contact with it. In a gas burner, heat from burning gas is convected upwards to the cooking utensil. In radiant glass cook tops, a heating element located below the glass surface radiates its energy upwards through the glass, which serves as a window and support for the utensil. Radiant heat is absorbed by the underside of the cooking utensil. Although radiant class cook tops are popular due to their appearance, they are notoriously inefficient and heat food much less quickly than other cooktop designs.

An exemplary embodiment of a cooktop burner having a thermally-sprayed resistive heating layer is illustrated in FIG. 13. A substrate 141 of the burner 140 comprises a flat plate of a suitable material. The substrate 141 can comprise a metal, such as cast iron. The substrate 141 can also comprise a non-metal, such as a ceramic, glass or mica. A heater coating 143 is located on the underside 142 of the substrate 141. The heater coating 143 can comprise a resistive heating layer that is thermally sprayed onto the underside 142 of the substrate 141, and patterned to provide a resistive heating circuit when a voltage is provided across electrodes 144 and 145. A porcelain protecting coating can be provided over the substrate 141 and/or heater 143. A porcelain coating over the top surface 146 of the substrate 141 can be colored to provide a decorative element to the burner. The burner 140 of FIG. 13 is advantageous relative to a conventional electric burner having a coiled Cal-rod because the heat is more evenly distributed across the entire surface of the substrate 141. Moreover, because the substrate 141 is typically a solid, flat plate, it is easy to clean and does not permit food or spills to fall below the heating element. In addition, a flat substrate can more easily accommodate a temperature sensor, such as a thermocouple. The addition of a thermocouple permits more accurate temperature control of the heating element.

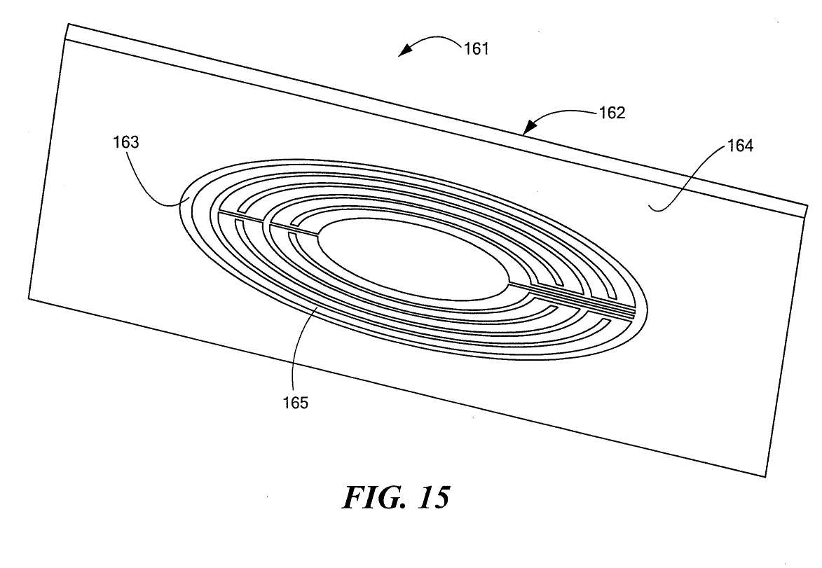

FIG. 14 illustrates an alternative burner configuration using a heater coating. In this embodiment, a separate heating element 153 is attached to a plate 151 that serves to support the cooking utensil, and transmit heat from the heating element to the cooking utensil. The separate element 153 can comprise a substrate 152 with a thermally-sprayed resistive heating layer 154 provided on the substrate. The substrate 152 can comprise mica, and the resistive heating layer can be thermally-sprayed directly on the mica substrate and patterned into a resistive heating circuit. The plate 151 can comprise a sturdy engineering material, such as cast iron. The separate element 153 is preferably removable from the plate 151, such that when the element burns out, the plate 151 can be re-used with a new element. Because the heater can be formed on an inexpensive substrate, such as mica, the cost of producing the heater is reduced.

FIG. 15 illustrates a cooktop having a thermally-sprayed heater coating according to yet another aspect of the invention. In a conventional glass cooktop, the glass surface typically serves as a support for the cooking utensil and as a window for transmitting radiant heat from a burner located 1-2 inches below the glass.

A heater coating of the present invention can be used to advantageously convert a glass cook top from radiantly heated to conductively heated, and improve overall efficiency. FIG. 15 illustrates a cooktop 161, which can comprise glass, having a flat, upper surface 162 for supporting a cooking utensil, and a bottom surface 164. A substrate 163 is provided directly under the bottom surface 164 of the cooktop 161 and in good thermal contact with the cooktop 161. A heater coating 165, which preferably comprises a thermally-sprayed heating layer that is patterned to form a resistive heating circuit, is provided on the substrate 163.

The substrate 163 can be, for example, mica, or can be any suitable material, such as a ceramic or a metal. It will be understood that the heater coating 165 can be deposited directly onto the underside 164 of the cooktop 161, obviating the need for a separate substrate 163.

An advantage of a cooktop 161 such as shown in FIG. 15 is that the positive temperature coefficient (PTC) nature of the heating element may be utilized for real-time temperature monitoring. This permits effective control of element temperature to prevent hazards, such as grease fires, and for more accurate burner temperature.

In certain embodiments, associated with each heating element as described in any of the preceding cooking appliances is a temperature sensor that is connected to the controller for controlling the power delivered to that element. The temperature sensor may be the heating element itself or it may be a separate temperature sensor such as a thermocouple, RTD or infrared detector that is in close proximity to the heating surface region for which the heating element is intended to provide temperature control. The temperature sensor may be a deposited layer adjacent to the heating element or a discrete device. Also associated with each heating element and temperature sensor are at least two electrical terminals and interconnections. The interconnections are preferably deposited layers but may also be wires, pins, or mechanical contacts attached using conventional electronic techniques such as micro welding, ball bonding, cementing, soldering, and brazing.

The controller and power supply are preferably connected to each heating element and each temperature sensor associated with each heating element. A plurality of heating elements and associated temperature sensor(s) can form an array. The controller and power supply provide energy to individual heating elements commensurate to the difference between the set point temperature, set by the user, and the temperature present at that point in time, as interpreted from the temperature sensor. In addition, the controller can have stored in memory the requisite data for interpreting temperature sensor information as temperatures and the necessary algorithms for accurate control of the surface temperature. In one configuration, the controller is capable of sensing the existence and location of a thermal load and its magnitude for individual elements by interpreting the rate of temperature rise registered by a temperature sensor in response to a known supplied energy input. For example, in the case of a cooktop with a multiple heating element array, when the controller supplies a pulse of electrical energy to each heating element of an array, then measures the temperature response to each heating element's output, it determines from the time response of temperature if a cooking utensil is above the element and the value of its present surface temperature. It therefore has acquired information on where the cooking utensils are located on the surface and what their current temperature is. In addition, the preferred controller has the capability to hold any heating element at a set maximum temperature and to a set maximum current or voltage. As such, it can apportion power to groups of heating elements where desired. Again, in the example of a cooktop, the controller can direct a large amount of power to a small group of heating elements, for example under a large cooking utensil that requires a large amount of power, while directing lower amounts to other cooking utensils. The temperature, current and voltage control allows this to happen, even though the entire heating element array over the surface is not powered with that level at one time due to the limited total power available to the heating apparatus.

The heating apparatus and control system as described will heat a surface either uniformly or to differing temperatures at arbitrarily designated locations with a number of advantages over conventional designs. The multiple heating element array provides for selective application of thermal energy only where it is needed. The heating elements allow a high degree of thermal efficiency and fast response by nature of their intimate bond to the surface and close proximity to the load. The addition of suitable electronic controls provides for thermal load sensing, thermal load follower PID control, variable power density to selected areas of the surface, over-temperature, current limit, and voltage level control. The ability to apply different layers to the heating surface adds great flexibility to the heating apparatus for achieving various properties such as safety, cleanability, durability, and appearance.

Examples of resistive heater coating layers and methods for the fabrication of heating elements, and various applications for heater coating layers, are described in commonly-owned U.S. Pat. Nos. 6,762,396, 6,919,543, 6,294,468 and 7,482,556, in commonly-owned U.S. Published Patent Applications Nos. 2003/0121906 A1, 2006/0288998 A1 and 2008/0217324 A1, and in commonly-owned U.S. patent application Ser. No. 12/156,438, filed on May 30, 2008. The entire teachings of the above-referenced patents and patent applications are incorporated herein by reference.

While the invention has been described in connection with specific methods and apparatus, those skilled in the art will recognize other equivalents to the specific embodiments herein. It is to be understood that the description is by way of example and not as a limitation to the scope of the invention and these equivalents are intended to be encompassed by the claims set forth below.

What is claimed is:

1. A cooking oven, comprising
a plurality of walls defining a oven cavity;
a heating element comprising at least one thermally-sprayed resistive heating layer, the resistive heating layer comprising a substantially lamellar structure comprising a first material and a second material, wherein the first material is an electrically conducting material and the second material is an electrically insulating material, the heating element in thermal communication with the oven cavity; and
at least one electrical connector in electrical contact with the resistive heating layer.

2. The oven of claim 1, further comprising:
a control system for controlling the temperature within the oven cavity, and
a support substrate, the heating layer being provided on the support substrate.

3. The oven of claim 2, wherein the support substrate comprises a wall that defines the oven cavity.

4. The oven of claim 2, further comprising an insulating layer, the insulating layer being provided on the support substrate and the heating layer being provided over the insulating layer, and the insulating layer comprising a thermally-sprayed layer comprising a substantially lamellar structure.

5. The oven of claim 2, wherein the support substrate comprises an electrically insulating material, and the heating layer is provided in contact with the support substrate.

6. The oven of claim 5, wherein the support substrate comprises at least one of mica and a polymer.

7. The oven of claim 2, wherein the support substrate comprises a substantially flat panel.

8. The oven of claim 1, wherein the heating layer is located inside the oven cavity.

9. The oven of claim 1, wherein the heating layer is located outside the oven cavity.

10. The oven of claim 3, further comprising a protective layer, the protective layer being provided over the heating layer and the support substrate, the protective layer comprising an insulating material.

11. The oven of claim 1, wherein the resistive heating layer is patterned to provide an electrical circuit, and at least two electrical connectors are in electrical contact with the resistive heating layer to provide a voltage across the circuit.

12. The oven of claim 1, wherein the bulk resistivity of the resistive heating layer is higher than the resistivity of the conductive material by a factor of about 10 or more.

13. The oven of claim 1, wherein the bulk resistivity of the resistive heating layer is higher than the resistivity of the conductive material by a factor of about 10 to about 1000.

14. The oven of claim 1, wherein the content of the electrically insulating material in the resistive heating layer comprises at least about 40% by volume.

15. The oven of claim 1, wherein the content of the electrically insulating material in the resistive heating layer comprises between about 40-80% by volume.

16. The oven of claim 1, wherein the electrically conductive material comprises a metallic material, and wherein the metallic material comprises at least one of titanium (Ti), vanadium (V), cobalt (Co), nickel (Ni), magnesium (Mg), zirconium (Zr), hafnium (Hf), aluminum (Al), tungsten (W), molybdenum (Mo), tantalum (Ta); silicon (Si), a metal alloy, a metal composite, and a metalloid.

17. The oven of claim 16, wherein the electrically insulating material comprises a reaction product of the metallic material, the reaction product comprising at least one of an oxide, a nitride, a carbide and a boride.

18. The oven of claim 1, wherein the electrically conductive material comprises aluminum and the electrically insulating material comprises aluminum oxide.

19. The oven of claim 1, wherein the electrically insulating material comprises a thermally-sprayed insulating material and a reaction product of the electrically conducting material.

20. The oven of claim 1, wherein the heating element is disposed on multiple surfaces around the oven cavity to promote substantially uniform distribution of radiant heat energy inside the oven cavity.

21. The oven of claim 20, wherein the multiple surfaces comprise walls of the oven cavity.

22. The oven of claim 1, wherein the heating element is disposed on a surface that is located within the oven cavity and mounted to at least one wall of the oven cavity.

23. The oven of claim 22, wherein the heating element is disposed on a surface panel that is mounted to the top wall of the oven cavity, the surface panel being spaced from the top wall by one or more spacers.

24. The oven of claim 1, further comprising:
an air circulation system that provides an air stream in thermal contact with the heating element to provide a conductive heating component within the oven cavity.

25. The oven of claim 24, wherein the air circulation system comprises a blower.

26. The oven of claim 25, wherein the heating element is located on a surface within the blower.

27. The oven of claim 1, wherein the heating element is disposed on a surface within the oven cavity to provide a conductive cooking surface.

28. The oven of claim 27, wherein the surface comprises a shelf within the oven cavity, and the shelf comprises a first heating element on a first surface of the shelf and a second heating element on a second surface of the shelf, and an insulation layer is between the first and second heating elements.

29. The oven of claim 28, wherein the control system independently controls the first heating element and the second heating element to provide a dual oven, and the shelf comprises an electrical connector that connects with a mating connector on the oven to provide power to the heating element.

30. The oven of claim 1, further comprising:
an oven rack within the oven cavity, the heater element being provided on the oven rack, and the oven rack comprising an electrical connector that connects with a mating connector on the oven to provide power to the heating element.

31. The oven of claim 1, further comprising:
a container within the oven cavity, the heater element being provided on the container to heat an object on the container; and
an electrical connector that connects the container to the oven, the control system controlling the operation of the container.

32. The oven of claim 1, wherein the oven comprises a pizza oven.

33. The oven of claim 32, wherein the interior of the oven cavity comprises a thermally-sprayed coating to provide a stone-like appearance to the interior of the oven.

34. The oven of claim 33, wherein the thermally-sprayed coating on the interior of the oven cavity comprises a ceramic material, the ceramic material comprising cordierite.

35. An air circulation system for a convection oven, comprising
an apparatus for providing an air stream;
a heating element comprising at least one thermally-sprayed resistive heating layer, the resistive heating layer comprising a substantially lamellar structure comprising a first material and a second material, wherein the first material is an electrically conducting material and the second material is an electrically insulating material, the heating element in thermal communication with the air stream; and
at least one electrical connector in electrical contact with the resistive heating layer.

36. The air circulation system of claim 35, wherein the apparatus comprises a blower, the heating element being disposed on a surface within the blower.

37. A heating element for an oven, comprising:
a support substrate;
a thermally-sprayed resistive heating layer on the support substrate, the resistive heating layer comprising a substantially lamellar structure comprising a first material and a second material, wherein the first material is an electrically conducting material and the second material is an electrically insulating material; and
at least one electrical connector in electrical contact with the resistive heating layer and configured to connect to a control system of an oven.

38. The heating element of claim 37, wherein the support substrate comprises a wall for providing an oven cavity.

39. The heating element of claim 37, further comprising an apparatus for mounting the heating element to a wall of an oven cavity.

40. The heating element of claim 39, wherein the apparatus for mounting comprises one or more spacers for securing the heating element to a wall of an oven cavity.

41. The heating element of claim 37, wherein the heating element comprises a shelf for insertion within an oven cavity.

42. The heating element of claim 41, wherein the shelf comprises a first resistive heating layer on a first surface of the shelf and a second resistive heating layer on a second surface of the shelf, and an insulation layer between the first and second heating layers.

43. The heating element of claim 37, wherein the heating element comprises an oven rack.

44. The heating element of claim 37, wherein the heating element comprises a container.

45. A method of fabricating an oven, comprising:
providing a substrate;
thermally spraying a resistive heating layer on the substrate, the resistive heating layer comprising a substantially lamellar structure comprising a first material and a second material, wherein the first material is an electrically conducting material and the second material is an electrically insulating material;
providing the resistive heating layer in thermal communication with an oven cavity; and
providing at least one electrical connection between the resistive heating layer and a power source.

46. The method of claim 45, wherein the resistive heating layer is thermally sprayed by at least one of an arc wire, flame spray, high-velocity oxy-fuel, arc plasma, and kinetic spray process.

47. The method of claim 46, further comprising one or more of:
thermally spraying an insulating layer on the substrate, the resistive heating layer being thermally sprayed over the insulating layer;
thermally spraying a protective layer over the resistive heating layer; and
providing a circuit pattern in the resistive heating layer.

48. The method of claim 47, wherein the circuit pattern is provided by at least one of:
thermally spraying the resistive heating layer over a removable patterned mask; and
removing portions of the resistive heating layer after the layer is thermally sprayed on the substrate.
